(19) United States
(12) Patent Application Publication
(10) Pub. No.: US 2026/0079997 A1
(43) Pub. Date: Mar. 19, 2026

(54) HIGH ENTROPY ELEMENT EXTRACTION USING MACHINE LEARNING MODELS

(71) Applicant: QUALCOMM Incorporated, San Diego, CA (US)

(72) Inventors: Anantharaman BALASUBRAMANIAN, San Diego, CA (US); Amr Mamoun MARTINI, San Diego, CA (US); Arvind Vardarajan SANTHANAM, San Diego, CA (US)

(21) Appl. No.: 18/888,974

(22) Filed: Sep. 18, 2024

(51) Int. Cl. G06F 16/35; G06F 16/33

(52) U.S. Cl. CPC G06F 16/353; G06F 16/3346

(57) ABSTRACT

Systems and techniques are provided for optimizing parameter extraction. For instance, a method for optimizing parameter extraction of queries is provided. The method can include extracting, from a query, a first element and a second element; determining an entropy level associated with the first element, the second element, and a plurality of input parameters; determining that the entropy level exceeds a threshold; based on the determination that the entropy level exceeds the threshold, determine a plurality of probabilities associated with mapping the first element and the second element to the plurality of input parameters; mapping, based on the plurality of probabilities, the first element to a first input parameter of the plurality of input parameters using a first machine learning model; and mapping, based on the plurality of probabilities, the second element to a second input parameter of the plurality of input parameters using a second machine learning model.

### FIELD

The present disclosure generally relates to element extraction using machine learning models. For example, aspects of the present disclosure relate to systems and techniques for extracting high entropy elements of queries using machine learning models (e.g., using element extraction and mapping techniques for high entropy elements).

### BACKGROUND

Machine learning models can be designed to process textual content to learn to recognize and classify textual elements, such as words, punctuation, phrases, and so forth. One such example of a machine learning model configured to process textual content is a large language model (LLM). Machine learning models, including LLMs, can be further designed to generate text based on the textual content. As an example, a machine learning model can be trained to perform natural language processing tasks, such as generating, predicting, translating, etc. text.

In some examples, machine learning models can be implemented using neural networks (NN), such as transformer models. A transformer model can be a type of machine learning model (e.g., a NN) that includes an encoder and decoder and may be used to tokenize inputs, learn relationships between the tokens, and then generate predictions using the tokens. Some machine learning models, such as LLMs are relatively large models that can be resource intensive to execute and can be prone to hallucinations (e.g., inaccuracies in predictions or outputs). Machine learning models are especially prone to hallucinations when the machine learning models lack sufficient information or training to make an accurate prediction. For example, machine learning models can sometimes hallucinate when asked to perform tasks to which the machine learning models lack sufficient context or training. The uncertainty in the predictions of a machine learning model is referred to as the entropy of the machine learning model. Higher uncertainty in predictions of machine learning models is correlated with a higher amount of entropy.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Systems and techniques are described for parameter extraction of one or more queries. In some aspects, an apparatus for parameter extraction of one or more queries is provided that includes at least one memory and at least one processor (e.g., configured in circuitry) coupled to the at least one memory. The at least one processor can: extract, from a query, a first element and a second element; determine an entropy level associated with the first element, the second element, and a plurality of input parameters; determine that the entropy level exceeds a threshold; based on the determination that the entropy level exceeds the threshold, determine a plurality of probabilities associated with mapping the first element and the second element to the plurality of input parameters; map, based on the plurality of probabilities, the first element to a first input parameter of the plurality of input parameters using a first machine learning model; and map, based on the plurality of probabilities, the second element to a second input parameter of the plurality of input parameters using a second machine learning model.

In some aspects, a method is provided for parameter extraction of one or more queries. The method includes: extracting, from a query, a first element and a second element; determining an entropy level associated with the first element, the second element, and a plurality of input parameters; determining that the entropy level exceeds a threshold; based on the determination that the entropy level exceeds the threshold, determine a plurality of probabilities associated with mapping the first element and the second element to the plurality of input parameters; mapping, based on the plurality of probabilities, the first element to a first input parameter of the plurality of input parameters using a first machine learning model; and mapping, based on the plurality of probabilities, the second element to a second input parameter of the plurality of input parameters using a second machine learning model.

In some aspects, a non-transitory computer-readable medium is provided that has stored thereon instructions that, when executed by one or more processors, cause the one or more processors to: extract, from a query, a first element and a second element; determine an entropy level associated with the first element, the second element, and a plurality of input parameters; determine that the entropy level exceeds a threshold; based on the determination that the entropy level exceeds the threshold, determine a plurality of probabilities associated with mapping the first element and the second element to the plurality of input parameters; map, based on the plurality of probabilities, the first element to a first input parameter of the plurality of input parameters using a first machine learning model; and map, based on the plurality of probabilities, the second element to a second input parameter of the plurality of input parameters using a second machine learning model.

In some aspects, an apparatus for parameter extraction of one or more queries is provided. The apparatus includes: means for extracting, from a query, a first element and a second element; means for determining an entropy level associated with the first element, the second element, and a plurality of input parameters; means for determining that the entropy level exceeds a threshold; based on the determination that the entropy level exceeds the threshold, determine a plurality of probabilities associated with mapping the first element and the second element to the plurality of input parameters; means for mapping, based on the plurality of probabilities, the first element to a first input parameter of the plurality of input parameters using a first machine learning model; and means for mapping, based on the plurality of probabilities, the second element to a second input parameter of the plurality of input parameters using a second machine learning model.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The preceding, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 illustrates an example implementation of a system-on-a-chip (SOC), in accordance with some examples, in accordance with aspects of the present disclosure;

FIG. 2A illustrates an example of a fully connected neural network, in accordance with aspects of the present disclosure;

FIG. 2B illustrates an example of a locally connected neural network, in accordance with aspects of the present disclosure;

FIG. 2C illustrates an example of a convolutional neural network (CNN), in accordance with aspects of the present disclosure;

FIG. 2D illustrates a detailed example of a deep convolutional network (DCN), in accordance with aspects of the present disclosure;

FIG. 3 is a block diagram illustrating an example of a deep convolutional network, in accordance with aspects of the present disclosure;

FIG. 4 is a block diagram illustrating an example system diagram for training a machine learning model for element extraction and mapping, in accordance with aspects of the present disclosure;

FIG. 5 is a block diagram illustrating an example system architecture 500 for a high entropy detection system, in accordance with aspects of the present disclosure;

FIG. 6 is a block diagram illustrating an example entropy detection engine 600 for predicting entropy associated with a query, in accordance with aspects of the present disclosure;

FIG. 7 is a block diagram illustrating independent graph mapping of extracted elements to input parameters, in accordance with aspects of the present disclosure;

FIG. 8 is a block diagram illustrating example cooperative graph mapping of a machine learning model and an external inference engine, in accordance with aspects of the present disclosure;

FIG. 9 is a flow diagram illustrating a process for high entropy parameter extraction, in accordance with aspects of the present disclosure;

FIG. 10 illustrates an example computing device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

As noted previously, machine learning models, such as neural networks (e.g., large language models (LLMs), transformer models, classification models, etc.), can be trained to process textual data to perform natural language processing tasks, such as generating, recognizing, extracting, predicting, translating, etc. text. One such natural language processing task can include extraction of elements from queries, and mapping of the extracted elements to categories, other elements, or other data.

Challenges remain in ensuring the reliability and accuracy of element extraction and mapping. Current machine learning models (e.g., LLMs or other models) can struggle with responding to requests (e.g., queries) that lack context or sufficient information. In some examples, LLMs can be prone generating incorrect or seemingly fabricated information (referred to as hallucinations) when presented with a request while lacking sufficient context to make predictions. Hallucinations can be especially problematic because LLMs generally present the hallucinations as accurate to users. The hallucinations are not always immediately evident as being incorrect or fabricated, requiring users to regularly audit outputs of LLMs for accuracy.

The accuracy of machine learning models performing element extraction as part of a broader system is especially important because accurate recognition and extraction of elements directly impacts the effectiveness and reliability of the broader system. Any inaccuracies in element extraction and mapping by the machine learning model can lead to further errors in the broader system. This is especially important when the machine learning models are implemented in systems where extracted elements are used as inputs for the system to perform other functions. For example, in industries relying on automated services, such as customer support services, inaccurate machine learning model outputs can cause customers to receive inaccurate information or cause the automated service to perform an unwanted action. In some cases, it can be useful to predict entropy (e.g., uncertainty) of predictions of a machine learning model based on inputs to determine whether the predictions can be trusted, or whether additional context is needed to perform a requested task.

Systems, apparatuses, electronic devices, methods (also referred to as processes), and computer-readable media (collectively referred to herein as “systems and techniques”) are described herein for extracting high entropy elements (e.g., words, phrases, etc.) from queries and mapping the high entropy elements to input parameters (e.g., of an application programming interface (API)). The systems and techniques can include various machine learning models, such as an LLM, a classification model, etc.

The systems and techniques can apply to element extraction from user queries and mapping the elements to input parameters of an API. A user query is a request provided by a user, such as a request to perform an action. User queries can be sentences represented by one or more strings (or series) of characters. Elements can be one or more words from the sentence. In some examples, the input parameters are input parameters of an API. The input parameters of the API are also referred to as slots of the API. The systems and techniques can include using various machine learning models to extract elements from a user query and map the extracted elements to input parameters of an API. The systems and techniques can include transmitting the extracted elements to the API as input parameters. The systems and techniques can include causing or triggering an application associated with the API to perform an action based on the extracted elements.

In some aspects, the systems and techniques can include receiving a user query and input parameters as input to an entropy detection engine. The entropy detection engine can include a machine learning model trained to determine an entropy level associated with the inputs to the system. In some examples, the machine learning model can determine the entropy level based on a trigger condition. For example, the trigger condition can be whether the query includes a request to perform a task (e.g., book a flight, order a product, etc.). In some examples, the entropy detection engine can include a machine learning model trained to perform named entity recognition (NER) of the query and the input parameters. The entropy detection engine can classify the input parameters and elements of the query into various classes based on subject matter. In some examples, the entropy detection engine can classify the input parameters and extracted elements of the query into various classes based on semantic similarities of the input parameters and the elements. For instance, a query can be a sentence clarifying where the user intends to travel, such as “I would like to fly from Atlanta to San Diego tomorrow.” The entropy detection engine can recognize and extract elements from the query that are associated with a class based on subject matter of the extracted element. The entropy detection engine can extract elements relevant to the task requested in the query. The entropy detection engine can determine not to extract other elements determined to be irrelevant, such as articles, adjectives, and prepositions unrelated to the task. The entropy detection engine can count the number of elements associated with the class. For instance, continuing the above example, the entropy detection engine can identify that the user query includes two locations (e.g., Atlanta and San Diego), a person (e.g., I), and a time (e.g., tomorrow). The entropy detection engine can count the number of input parameters associated with the various classes. The entropy detection engine can compare the number of extracted elements associated with the various classes to the number of input parameters associated with the various classes. When there is a deviation between the number of input parameters associated with a class and the number of elements associated with the class, the entropy detection engine can flag the elements associated with the class as representing high entropy.

In some aspects, the entropy detection engine can flag the elements when the deviation between the number of input parameters associated with the class and the number of elements associated with the class exceeds a predetermined threshold. For example, the entropy detection engine can have a threshold allowing for a predetermined number of deviations in numbers per class. In one example, the entropy detection engine can have a predetermined threshold of two, indicating that the entropy detection engine can flag elements associated with a class when the number of elements is at least two greater than the number of input parameters associated with the class.

When the entropy detection engine detects high entropy associated with one or more elements of a user query, the entropy detection engine can flag the one or more elements of the user query to be reviewed by an external inference engine. The external inference engine can map flagged elements to input parameters, and a second machine learning model can map elements which were not flagged to input parameters. The second machine learning model can be a separate component from the machine learning model of the entropy detection engine. In some cases, the entropy detection engine can determine to use multiple machine learning models (e.g., the first machine learning model and the second machine learning model) based on a trigger condition that includes the entropy level associated with the first element, the second element, and the plurality of input parameters exceeding the threshold.

In some aspects, when an element of the user query is flagged as being associated with high entropy, the entropy detection engine can flag the entire user query. For example, the entropy detection engine can flag individual elements or elements within a particular class. The external inference engine can include a machine learning model trained to map extracted elements to the input parameters. In some examples, the entropy detection engine can provide flagged elements and input parameters to the external inference engine. In some examples, the entropy detection engine can provide the user query and the input parameters to the external inference engine.

The external inference engine can map extracted elements to input parameters using various probabilistic techniques. In one such example, the external inference engine can generate embedding vectors associated with extracted elements and embedding vectors associated with the input parameters. The external inference engine can compare distances between embedding vectors associated with the extracted elements and embedding vectors associated with the input parameters in an embedding space. The external inference engine can generate probabilities indicating an amount of certainty the external inference engine predicts an extracted element maps to an input parameter. In some examples, the external inference engine can flag an input parameter or extracted element as having a low probability of mapping to any of the input parameters. In such an example, the external inference engine can determine not to map the extracted element to any of the input parameters.

In some aspects, the external inference engine can include a machine learning model with different weights from the second machine learning model. The external inference engine can include a machine learning model, such as an LLM, tuned to map elements associated with predetermined classes (e.g., classes from the entropy detection engine).

In some aspects, the external inference engine can receive probability distributions associated with mapping one or more extracted element to one or more input parameters from the second machine learning model, such as an LLM. The second machine learning model can provide conditional probabilities associated with mapping an extracted element to all possible input parameters. In some examples, the second machine learning model can provide conditional probabilities associated with mapping all extracted elements to all possible input parameters. In further examples, the second machine learning model can provide conditional probabilities associated with the extracted elements flagged by the entropy detection engine.

In some aspects, the entropy detection engine can provide the extracted elements that were not flagged to the second machine learning model. For example, the second machine learning model can receive the user query and input parameters independently of the entropy detection engine. In some examples, the second machine learning model receives extracted elements from the entropy detection engine that were not flagged as being associated with high entropy (e.g., elements associated with a class exceeding the predetermined threshold). The second machine learning model can map the extracted elements that were not flagged by the entropy detection engine.

The external inference engine and the second machine learning model can perform separate mappings of extracted elements to the input parameters. The separate mappings (e.g., partial inferences) can be combined to generate a joint inference. For example, one or more of the second machine learning model and the external inference engine can generate the joint inference. In some examples, a joint inference engine can receive the separate mappings to generate the joint inference.

Various aspects of the present disclosure will be described with respect to the figures.

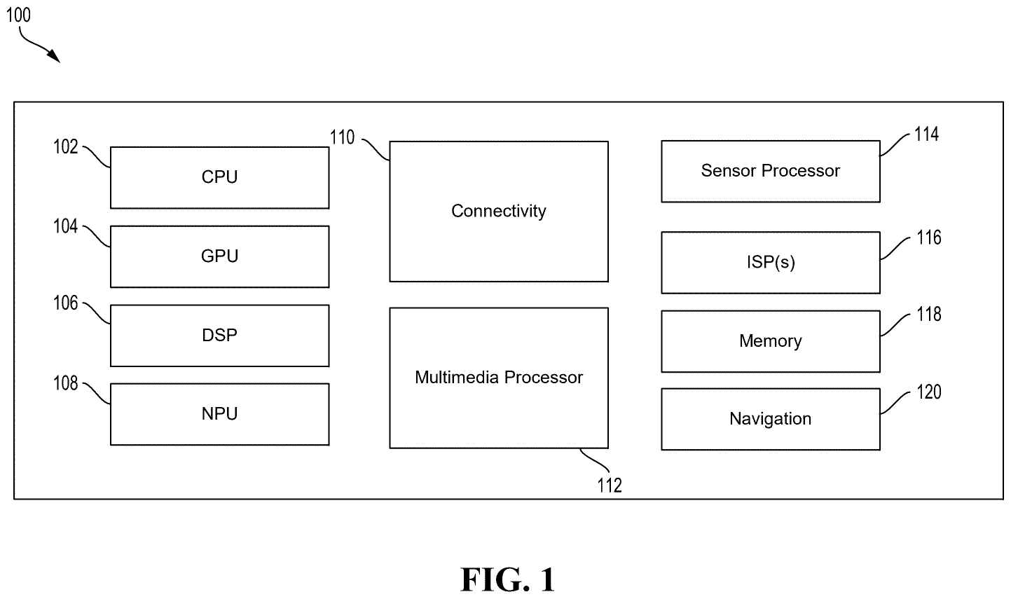

FIG. 1 illustrates an example implementation of a system-on-a-chip (SOC) 100, which may include a central processing unit (CPU) 102 or a multi-core CPU, configured to perform one or more of the functions described herein. Parameters or variables (e.g., neural signals and synaptic weights), system parameters associated with a computational device (e.g., neural network with weights), delays, frequency bin information, task information, among other information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, and/or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM instruction set. SOC 100 and/or components thereof may be configured to perform segmentation mask extrapolation. For example, the CPU 102, DSP 106, and/or GPU 104 may be configured to perform object detection using a visual language model via latent feature adaptation with synthetic data.

In some cases, the SOC 100 may process data using neural networks and/or machine learning (ML) systems. A neural network is an example of an ML system, and a neural network can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low level characteristics of an input, and later layers building up a hierarchy of more complex and abstract characteristics

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may bene-fit from first learning to recognize wheels, windshields, and other features. These features may be combined at higher layers in different ways to recognize cars, trucks, and airplanes.

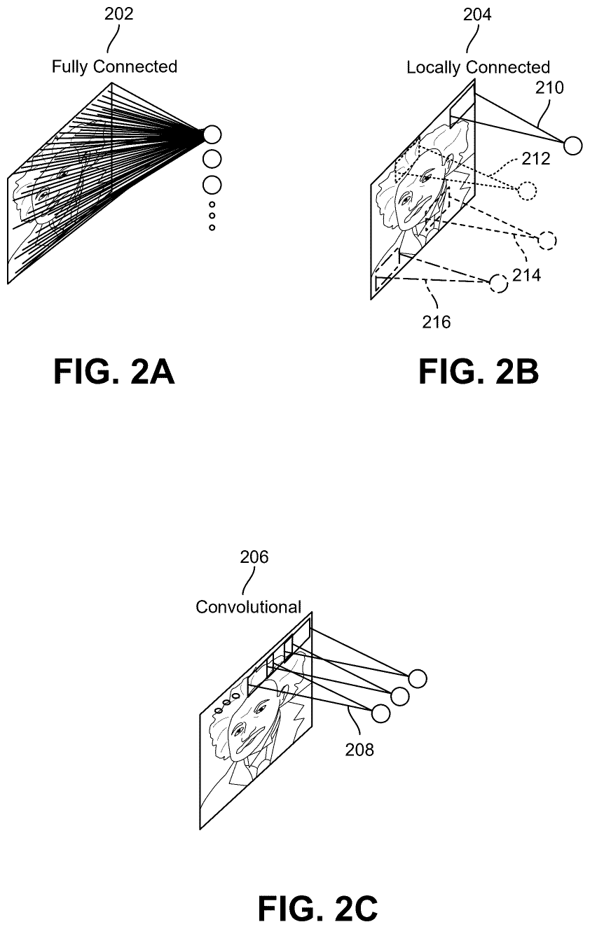

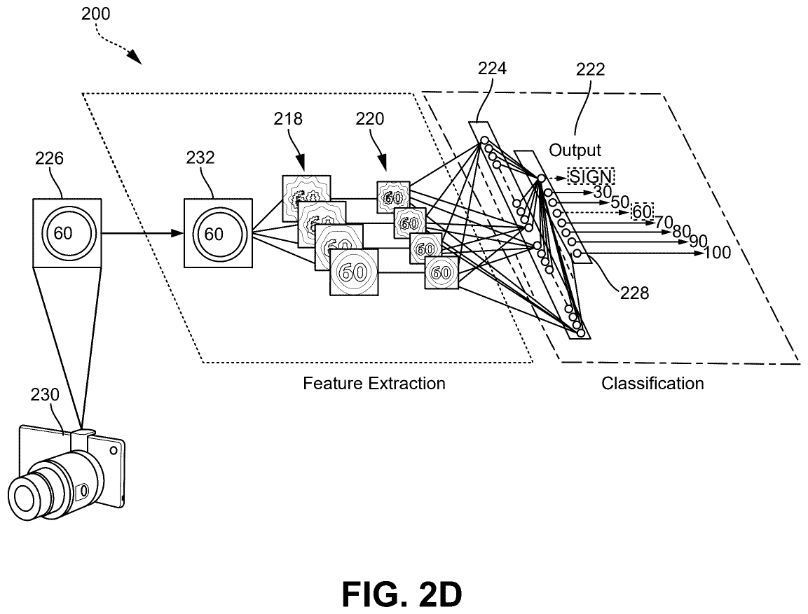

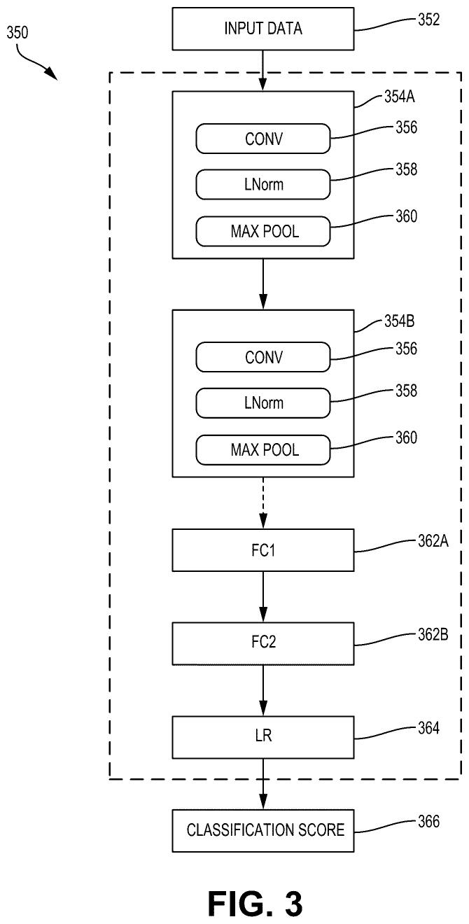

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same lay-er. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input. The connections between layers of a neural network may be fully connected or locally connected. Various examples of neural network architectures are described below with respect to FIG. 2A-FIG. 3.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same lay-er. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

The connections between layers of a neural network may be fully connected or locally connect-ed. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer, because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful. Convolutional neural network 206 may be used to perform one or more aspects of video compression and/or decompression, according to aspects of the present disclosure.

One type of convolutional neural network is a deep convolutional network (DCN). FIG. 2D illustrates a detailed example of a DCN 200 designed to recognize visual features from an image 226 input from an image capturing device 230, such as an image capture and processing system based on SOC 100 of FIG. 1. The DCN 200 of the current example may be trained to identify traffic signs and a number provided on the traffic sign. Of course, the DCN 200 may be trained for other tasks, such as identifying lane markings or identifying traffic lights.

The DCN 200 may be trained with supervised learning. During training, the DCN 200 may be presented with an image, such as the image 226 of a speed limit sign, and a forward pass may then be computed to produce an output 222. The DCN 200 may include a feature extraction section and a classification section. Upon receiving the image 226, a convolutional layer 232 may apply convolutional kernels (not shown) to the image 226 to generate a first set of feature maps 218. As an example, the convolutional kernel for the convolutional layer 232 may be a 5×5 kernel that generates 28×28 feature maps. In the present example, because four different feature maps are generated in the first set of feature maps 218, four different convolutional kernels were applied to the image 226 at the convolutional layer 232. The convolutional kernels may also be referred to as filters or convolutional filters.

The first set of feature maps 218 may be subsampled by a max pooling layer (not shown) to generate a second set of feature maps 220. The max pooling layer reduces the size of the first set of feature maps 218. That is, a size of the second set of feature maps 220, such as 14×14, is less than the size of the first set of feature maps 218, such as 28×28. The reduced size provides similar information to a subsequent layer while reducing memory consumption. The second set of feature maps 220 may be further convolved via one or more subsequent convolutional layers (not shown) to generate one or more subsequent sets of feature maps (not shown).

In the example of FIG. 2D, the second set of feature maps 220 is convolved to generate a first feature vector 224. Furthermore, the first feature vector 224 is further convolved to generate a second feature vector 228. Each feature of the second feature vector 228 may include a number that corresponds to a possible feature of the image 226, such as “sign,” “60,” and “100.” A softmax function (not shown) may convert the numbers in the second feature vector 228 to a probability. As such, an output 222 of the DCN 200 is a probability of the image 226 including one or more features.

In the present example, the probabilities in the output 222 for “sign” and “60” are higher than the probabilities of the others of the output 222, such as “30,” “40,” “50,” “70,” “80,” “90,” and “100”. Before training, the output 222 produced by the DCN 200 is likely to be incorrect. Thus, an error may be calculated between the output 222 and a target output. The target output is the ground truth of the image 226 (e.g., “sign” and “60”). The weights of the DCN 200 may then be adjusted so the output 222 of the DCN 200 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. Adjusting the weights in such a manner may be referred to as “back propagation” as it involves a “backward pass”through the neural network.

In practice, the error gradient of weights may be calculated over a small number of examples, so that the calculated gradient approximates the true error gradient. The approximation method may be referred to as stochastic gradient descent. Stochastic gradient descent may be repeated until the achievable error rate of the entire system has stopped decreasing or until the error rate has reached a target level. After learning, the DCN may be presented with new images and a forward pass through the network may yield an output 222 that may be considered an inference or a prediction of the DCN.

Deep convolutional networks (DCNs) are networks of convolutional networks, configured with additional pooling and normalization layers. DCNs have achieved state-of-the-art performance on many tasks. DCNs can be trained using supervised learning in which both the input and out-put targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., feature maps 220) receiving input from a range of neurons in the previous layer (e.g., feature maps 218) and from each of the multiple channels. The values in the feature map may be further processed with a non-linearity, such as a rectification, max(0,x). Values from adjacent neurons may be further pooled, which corresponds to down sampling, and may provide additional local invariance and dimensionality reduction.

FIG. 3 is a block diagram illustrating an example of a deep convolutional network 350. The deep convolutional network 350 may include multiple different types of layers based on connectivity and weight sharing. As shown in FIG. 3, the deep convolutional network 350 includes the convolution blocks 354A, 354B. Each of the convolution blocks 354A, 354B may be configured with a convolution layer (CONV) 356, a normalization layer (LNorm) 358, and a max pooling layer (MAX POOL) 360. Of note, the layers illustrated with respect to convolution blocks 354A and 354B are examples of layers that may be included in a convolution layer and are not intended to be limiting and other types of layers may be included in any order.

The convolution layers 356 may include one or more convolutional filters, which may be ap-plied to the input data 352 to generate a feature map. Although only two convolution blocks 354A, 354B are shown, the present disclosure is not so limiting, and instead, any number of convolution blocks (e.g., convolution blocks 354A, 354B) may be included in the deep convolutional network 350 according to design preference. The normalization layer 358 may normalize the output of the convolution filters. For example, the normalization layer 358 may provide whitening or lateral inhibition. The max pooling layer 360 may provide down sampling aggregation over space for local invariance and dimensionality reduction.

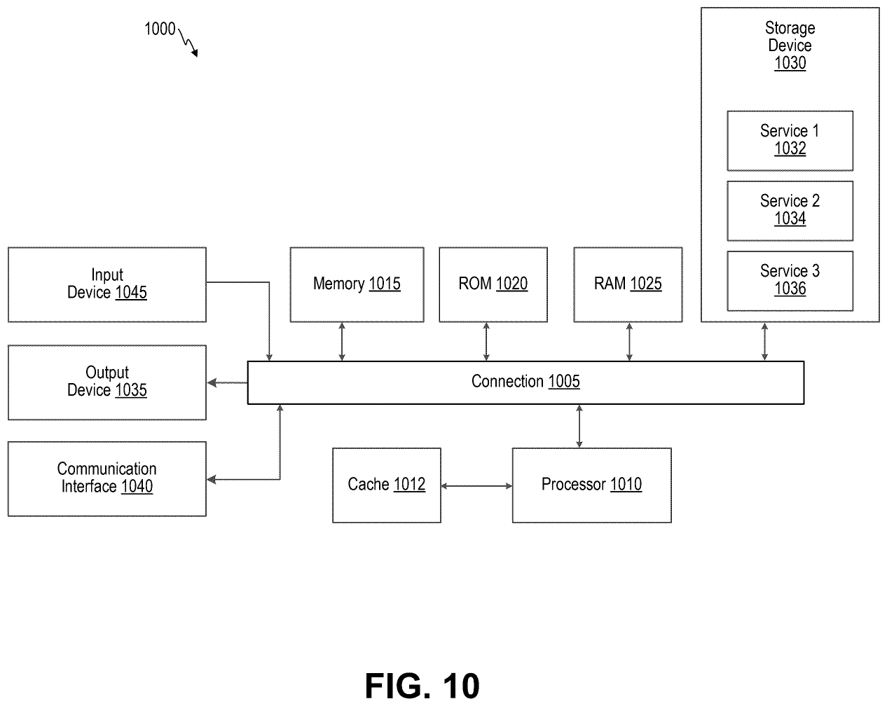

The parallel filter banks, for example, of a deep convolutional network may be loaded on a processor such as a CPU, GPU, NPU, or any other type of processor 1010 discussed with respect to the computing system 1000 of FIG. 10 to achieve high performance and low power consumption. In alternative aspects, the parallel filter banks may be loaded on a DSP or an ISP of the computing system 1000. In addition, the deep convolutional network 350 may access other processing blocks that may be present on the computing system 1000 of FIG. 10, such as a sensor processor and navigation module, dedicated, respectively, to sensors and navigation.

The deep convolutional network 350 may also include one or more fully connected layers, such as layer 362A (labeled “FC1”) and layer 362B (labeled “FC2”). The deep convolutional network 350 may further include a logistic regression (LR) layer 364. Between each layer 356, 358, 360, 362A, 362B, 364 of the deep convolutional network 350 are weights (not shown) that are to be updated. The output of each of the layers (e.g., 356, 358, 360, 362A, 362B, 364) may serve as an input of a succeeding one of the layers (e.g., 356, 358, 360, 362A, 362B, 364) in the deep convolutional network 350 to learn hierarchical feature representations from input data 352 (e.g., images, audio, video, sensor data and/or other input data) supplied at the first of the convolution blocks 354A. The output of the deep convolutional network 350 is a classification score 366 for the input data 352. The classification score 366 may be a set of probabilities, where each probability is the probability of the input data including a feature from a set of features.

In some cases, one or more convolutional networks, such as a DCN, may be incorporated into more complex ML networks. As an example, as indicated above, the deep convolutional network 350 may output probabilities that an input data, such as an image, includes certain features. The deep convolutional network 350 may then be modified to extract (e.g., output) certain features. Additionally, DCNs may be added to extract other features as well. The set of DCNs may function as feature extractors to identify features in an image. In some cases, feature extractors may be used as a backbone for additionally ML network components to perform further operations, such as image segmentation, extraction of elements from queries, classifying extracted elements, and mapping extracted elements to input parameters.

In some cases, CNN and/or DCNs may be generalized in the form of a transformer network. A transformer network may extract features from an input sequence and the transformer network may include attention mechanisms that may enable the transformer network to process input sequences in a parallel and efficient manner. An attention mechanism allows the model to focus on different parts of the input sequence at different times. Attention mechanisms may be implemented using a series of layers known as attention layers to compute weighted sums of input features based on a similarity between different elements of the input sequence. A transformer network may include a series of feedforward layers whose configurations may change in response to identifying non-linear relationships between the input and output sequences, which may also be referred to as a process of “learning” by the layers. The output of a transformer structure may be obtained by applying a linear transformation to the output of a final attention layer. A transformer structure may be of particular use for tasks that involve sequence modeling, text generation, or other like processing.

The neural network architectures described with respect to FIGS. 2A-2D and FIG. 3 can also be used as the architecture of a machine learning model configured to perform tasks involving named entity recognition, natural language processing, element extraction from queries, classifying extracted elements, mapping extracted elements to input parameters, and generating a joint inference based on multiple mappings. In some examples, the neural network architectures described in FIGS. 2A-2D and FIG. 3 can provide the architecture for a large language model (LLM).

As noted previously, systems and techniques are described herein for extracting high entropy elements (e.g., words, phrases, etc.) from queries and mapping the high entropy elements to input parameters (e.g., of an application programming interface (API)). The systems and techniques can make use of multiple machine learning models, such as an LLM, a classification model, etc., which in some cases can include the neural network architectures described with respect to FIGS. 2A-2D and FIG. 3 and/or other neural network architectures (e.g., using one or more transformer neural network architectures).

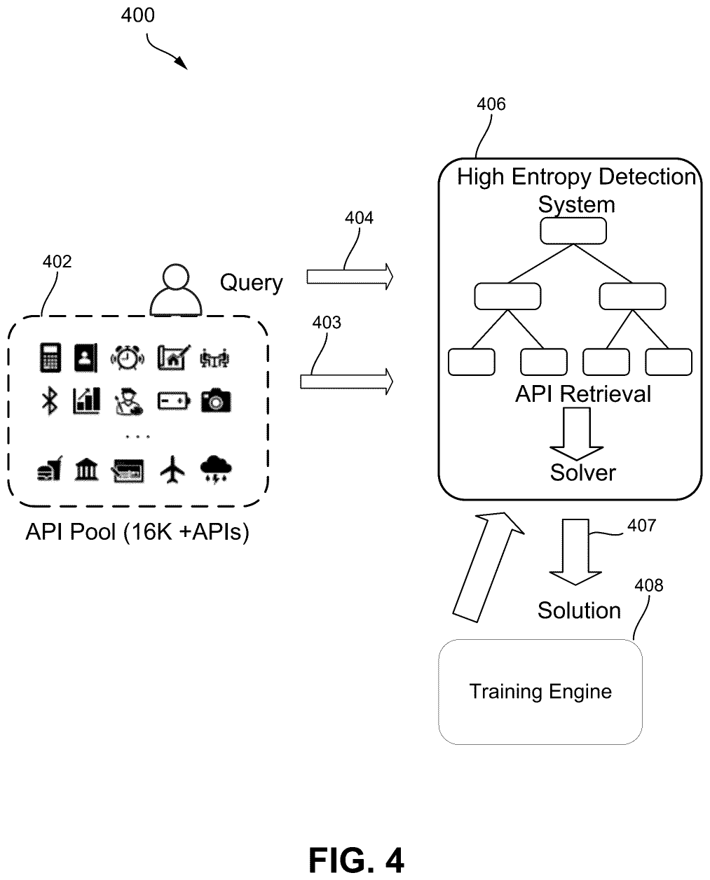

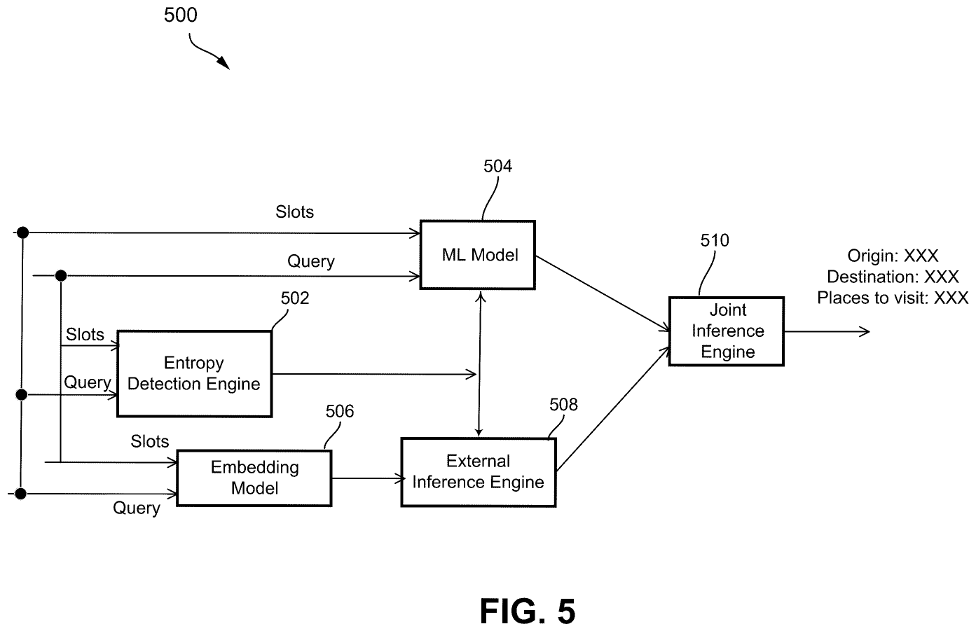

FIG. 4 is a block diagram illustrating an example system diagram 400 for training a machine learning model for element extraction and mapping. The example system diagram 400 includes an application programming interface (API) pool 402, input parameters 403, a query 404, a high entropy detection system 406, a combined mapping, and a training engine 408. Further description of the high entropy detection system 406 is provided in the description of FIGS. 5-8.

The API pool 402 represents a set of all APIs that can be integrated into the high entropy detection system 406. In some examples, API pool 402 is a database of APIs and input parameters 403 associated with each API. Each API of the API pool 402 can include associated input parameters 403. The input parameters 403 represent inputs to the API that an application associated with the API uses to perform actions. For example, an API associated with an application for booking flights can include input parameters 403 such as departure date, origin, destination, number of passengers, etc. The API pool 402 can provide the input parameters 403 to the high entropy detection system 406. In some examples, the high entropy detection system 406 can retrieve the input parameters 403 based on a user selection. In some examples, the user selection can be part of the query 404. The user provides the query 404 to the high entropy detection system 406, such as by typing a request into an input field of an application associated with the high entropy detection system 406. In further examples, the high entropy detection system 406 can infer the API to use based on the query 404. The high entropy detection system 406 can retrieve input parameters 403 from the API pool 402 based on the inference.

The high entropy detection system 406 extracts elements from the query 404. The high entropy detection system 406 classifies the extracted elements and the input parameters. The high entropy detection system 406 determines an entropy level associated with the extracted elements and the input parameters. Based on the entropy level, the high entropy detection system 406 can apportion extracted elements and input parameters to various engines or machine learning models. The various engines and machine learning models can map the extracted elements to the input parameters. The high entropy detection system 406 can combine the mappings of the various engines and machine learning models to determine a combined mapping 407 of the extracted elements to the input parameters.

The combined mapping 407 is provided to or otherwise received by the training engine 408. The training engine 408 can perform various training processes, such as iterative loss training techniques to minimize a loss function. The training engine 408 can adjust weights of the machine learning models associated with the high entropy detection system to reduce differences in the combined mapping 407 and training data.

In some aspects, training of one or more of the machine learning systems or neural networks described herein (e.g., such as the neural networks of FIGS. 2A-2D and FIG. 3, among various other machine learning networks described herein) can be performed using online training (e.g., in some case on-device training), offline training, and/or various combinations of online and offline training. In some cases, online can refer to time periods during which the input data (e.g., such as an input query to a large language model (LLM), etc.) is processed, for instance for performance of optimizing weights of the neural network so that the neural network is more easily quantized (e.g., requires less resources to quantize) while maintaining accuracy of the neural network. In some examples, offline can refer to idle time periods or time periods during which input data is not being processed. Additionally, offline can be based on one or more time conditions (e.g., after a particular amount of time has expired, such as a day, a week, a month, etc.) and/or can be based on various other conditions such as network and/or server availability, etc., among various others. In some aspects, offline training of a machine learning model (e.g., a neural network model) can be performed by a first device (e.g., a server device) to generate a pre-trained model, and a second device can receive the trained model from the second device. In some cases, the second device (e.g., a mobile device, an XR device, a vehicle or system/component of the vehicle, or other device) can perform online (or on-device) training of the pre-trained model to further adapt or tune the parameters of the model.

FIG. 5 is a block diagram illustrating an example system architecture 500 for a high entropy detection system. The example system architecture 500 includes an entropy detection engine 502, a machine learning model 504, an embedding model 506, external inference engine 508, and a joint inference engine 510.

In some examples, the entropy detection engine 502, the machine learning model 504, the embedding model 506, and the external inference engine 508 can independently receive input parameters (e.g., slots) and queries. Queries can be inputs from a user requesting performance of a task. For example, a query can be a request represented as a sentence input by the user. The words of the sentence can represent various elements of the query. The input parameters (e.g., referred to as slots in FIG. 5) can represent input parameters of an application programming interface (API) or function. For example, the input parameters can represent variables which when provided to the API, cause an application to perform an action based on the input parameters.

The entropy detection engine 502 receives a query and input parameters. The entropy detection engine 502 can include a machine learning model configured to determine an entropy level associated with the queries and input parameters. For example, the entropy detection engine 502 can be used to determine whether enough context is provided within the query to perform a requested task. The entropy detection engine 502 can be used to determine whether extraneous information is included in the query that can cause errors in mapping elements of the query to the input parameters.

For example, the entropy detection engine can include a machine learning model trained to perform named entity recognition (NER) of the query and the input parameters. The entropy detection engine 502 classifies the input parameters and elements of the query into various classes based on subject matter. In some examples, the entropy detection engine 502 can classify the input parameters and extracted elements of the query into various classes based on semantic similarities of the input parameters and the elements. The entropy detection engine 502 can recognize and extract elements from the query that are associated with a class based on subject matter of the extracted element.

The entropy detection engine 502 can count the number of elements and input parameters associated with the class. The entropy detection engine 502 compares the number of extracted elements associated with the class to the number of input parameters associated with the class. Deviations in the number of input parameters associated with the class and the number of extracted elements associated with the class are used to determine an entropy level associated with the class of elements. For example, the entropy level can be the number of deviations in numbers of extracted elements of a particular class compared to the numbers of input parameters of the particular class (e.g., entropy level=2 when there are two more extracted elements of a class than input parameters of the class). When the entropy level exceeds a predetermined threshold (e.g., an entropy level threshold), the entropy detection engine 502 can flag the extracted elements associated with the class to be mapped by the external inference engine 508. In some examples, instead of or in addition to flagging extracted elements associated with a high entropy level (e.g., an entropy level exceeding the predetermined threshold), the entropy detection engine 502 can enable the external inference engine 508. In further examples, the external inference engine 508 can receive the query and input parameters when enabled.

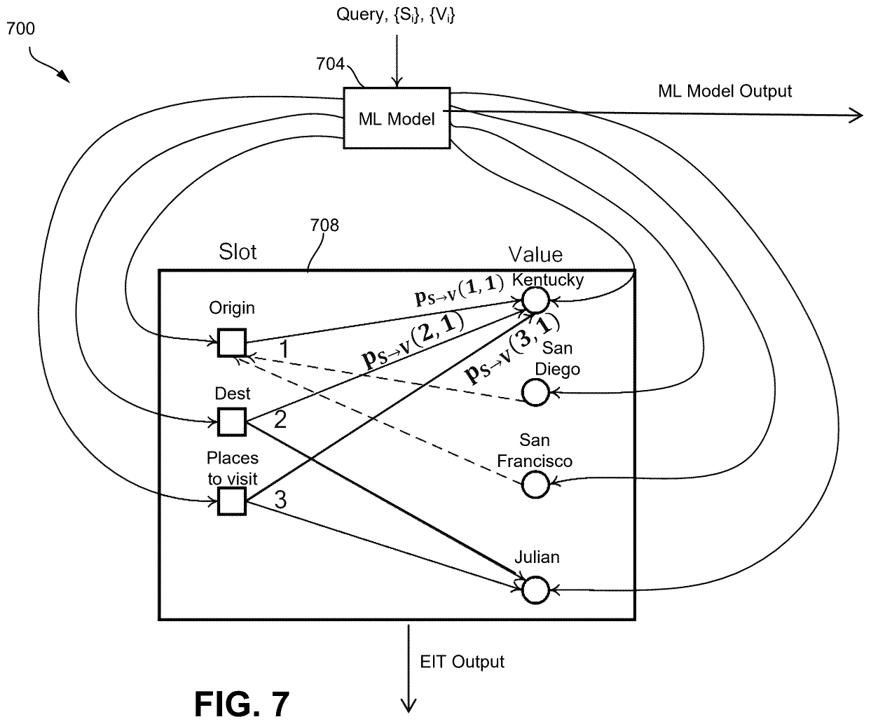

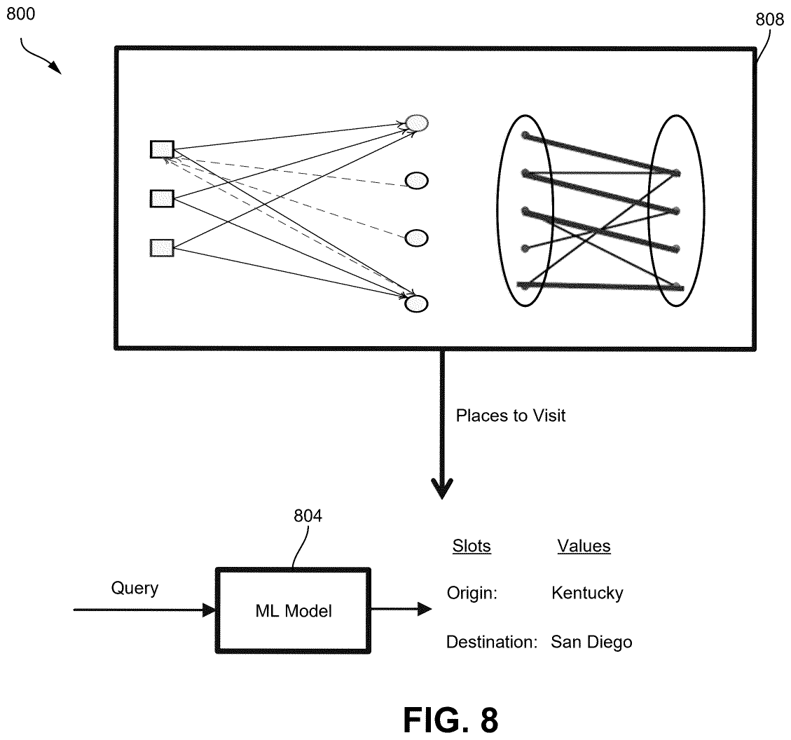

The external inference engine 508 receives the query and input parameters. In some examples, the external inference engine 508 receives extracted elements associated with a high entropy level and input parameters associated with the high entropy level. The external inference engine 508 maps extracted elements associated with the high entropy level to input parameters. Further description of the mapping process is provided in the description of FIG. 7 and FIG. 8. In some examples, the external inference engine 508 is configured to extract the elements from the query using named entity recognition (NER). In further examples, the external inference engine 508 can use the elements extracted by the entropy detection engine 502. In additional examples, the embedding model 506 can receive the query and the input parameters. The embedding model 506 can generate an embedding representation (e.g., an embedding vector) of elements of the query and an embedding representation of the input parameters. In some examples, the external inference engine 508 receives the embedding representations. In further examples, the embedding model 506 is part of the external inference engine 508.

The external inference engine 508 can include a machine learning model configured to map extracted elements to the input parameters. The external inference engine 508 can map extracted elements to input parameters using various probabilistic techniques. For example, can compare distances between embedding representations associated with extracted elements and embedding representations associated with the input parameters in an embedding space. The external inference engine 508 can generate probabilities indicating an amount of certainty the external inference engine 508 predicts an extracted element maps to an input parameter.

The external inference engine 508 can include a machine learning model with different weights from machine learning model 504. For example, the external inference engine 508 can include an LLM tuned to map elements associated with particular classes (e.g., the classes from the entropy detection engine 502).

In some examples, the external inference engine 508 receives probability distributions associated with mapping one or more extracted element to one or more input parameters from the machine learning model 504. Machine learning model 504 can be various types of machine learning models, such as an LLM or classification model. In some examples, machine learning model 504 can provide conditional probabilities to the external inference engine 508 associated with mapping an extracted element to all possible input parameters. In further examples, the machine learning model 504 can provide conditional probabilities associated with mapping all extracted elements to all possible input parameters. In some examples, machine learning model 504 can provide conditional probabilities associated with the extracted elements flagged by the entropy detection engine 502.

In some examples, the entropy detection engine 502 can provide the extracted elements that were not flagged to machine learning model 504. In further examples, machine learning model 504 can receive the user query and input parameters independently of the entropy detection engine 502. For example, the machine learning model 504 can perform named entity recognition (NER) to extract elements from the query. In further examples, the machine learning model 504 receives extracted elements from the entropy detection engine 502 that were not flagged as being associated with high entropy (e.g., elements associated with a class exceeding the predetermined threshold). The machine learning model 504 can map the extracted elements that were not flagged by the entropy detection engine. In some examples, the machine learning model 504 and the external inference engine 508 individually map each of the extracted elements to the input parameters.

The external inference engine 508 and the machine learning model 504 can perform separate mappings of extracted elements to the input parameters. The joint inference engine 510 can combine results of the separate mappings (e.g., partial inferences) to generate a joint inference. For example, the machine learning model 504 and the external inference engine 508 can apportion extracted elements and input parameters to be mapped based on the entropy level. The joint inference engine 510 can combine the mappings to generate the joint inference. In some examples, portions of the mapping (e.g., values for a first set of input parameters) can be performed by the external inference engine 508 and other portions of the mapping (e.g., values for a second set of input parameters) can be performed by the machine learning model 504. In another example, the external inference engine 508 and the machine learning model 504 can each independently map extracted elements to the input parameters. The joint inference engine 510 can compare the independent mappings of the external inference engine 508 and the machine learning model 504. When there are inconsistencies between the mappings of the external inference engine 508 and the machine learning model 504, the joint inference engine 510 can trigger a prompt to a user including a clarifying question or request for clarification associated with the inconsistent mapping.

In some examples, the entropy detection engine 502, the machine learning model 504, the embedding model 506, and the external inference engine 508 can independently receive input parameters (e.g., slots) and queries. Queries can be inputs from a user requesting performance of a task. For example, a query can be a request represented as a sentence input by the user. The words of the sentence can represent various elements of the query. The input parameters (e.g., referred to as slots in FIG. 5) can represent input parameters of an application programming interface (API) or function. For example, the input parameters can represent variables which when provided to the API, cause an application to perform an action based on the input parameters.

The entropy detection engine 502 receives a query and input parameters. The entropy detection engine 502 can include a machine learning model configured to determine an entropy level associated with the queries and input parameters. For example, the entropy detection engine 502 can be used to determine whether enough context is provided within the query to perform a requested task. The entropy detection engine 502 can be used to determine whether extraneous information is included in the query that can cause errors in mapping elements of the query to the input parameters.

For example, the entropy detection engine can include a machine learning model trained to perform named entity recognition (NER) of the query and the input parameters. The entropy detection engine 502 classifies the input parameters and elements of the query into various classes based on subject matter. In some examples, the entropy detection engine 502 can classify the input parameters and extracted elements of the query into various classes based on semantic similarities of the input parameters and the elements. The entropy detection engine 502 can recognize and extract elements from the query that are associated with a class based on subject matter of the extracted element.

The entropy detection engine 502 can count the number of elements and input parameters associated with the class. The entropy detection engine 502 compares the number of extracted elements associated with the class to the number of input parameters associated with the class. Deviations in the number of input parameters associated with the class and the number of extracted elements associated with the class are used to determine an entropy level associated with the class of elements. For example, the entropy level can be the number of deviations in numbers of extracted elements of a particular class compared to the numbers of input parameters of the particular class (e.g., entropy level=2 when there are two more extracted elements of a class than input parameters of the class). When the entropy level exceeds a predetermined threshold (e.g., an entropy level threshold), the entropy detection engine 502 can flag the extracted elements associated with the class to be mapped by the external inference engine 508. In some examples, instead of or in addition to flagging extracted elements associated with a high entropy level (e.g., an entropy level exceeding the predetermined threshold), the entropy detection engine 502 can enable the external inference engine 508. In further examples, the external inference engine 508 can receive the query and input parameters when enabled.

The external inference engine 508 receives the query and input parameters. In some examples, the external inference engine 508 receives extracted elements associated with a high entropy level and input parameters associated with the high entropy level. The external inference engine 508 maps extracted elements associated with the high entropy level to input parameters. Further description of the mapping process is provided in the description of FIG. 7 and FIG. 8. In some examples, the external inference engine 508 is configured to extract the elements from the query using named entity recognition (NER). In further examples, the external inference engine 508 can use the elements extracted by the entropy detection engine 502. In additional examples, the embedding model 506 can receive the query and the input parameters. The embedding model 506 can generate an embedding representation (e.g., an embedding vector) of elements of the query and an embedding representation of the input parameters. In some examples, the external inference engine 508 receives the embedding representations. In further examples, the embedding model 506 is part of the external inference engine 508.

The external inference engine 508 can include a machine learning model configured to map extracted elements to the input parameters. The external inference engine 508 can map extracted elements to input parameters using various probabilistic techniques. For example, can compare distances between embedding representations associated with extracted elements and embedding representations associated with the input parameters in an embedding space. The external inference engine 508 can generate probabilities indicating an amount of certainty the external inference engine 508 predicts an extracted element maps to an input parameter.

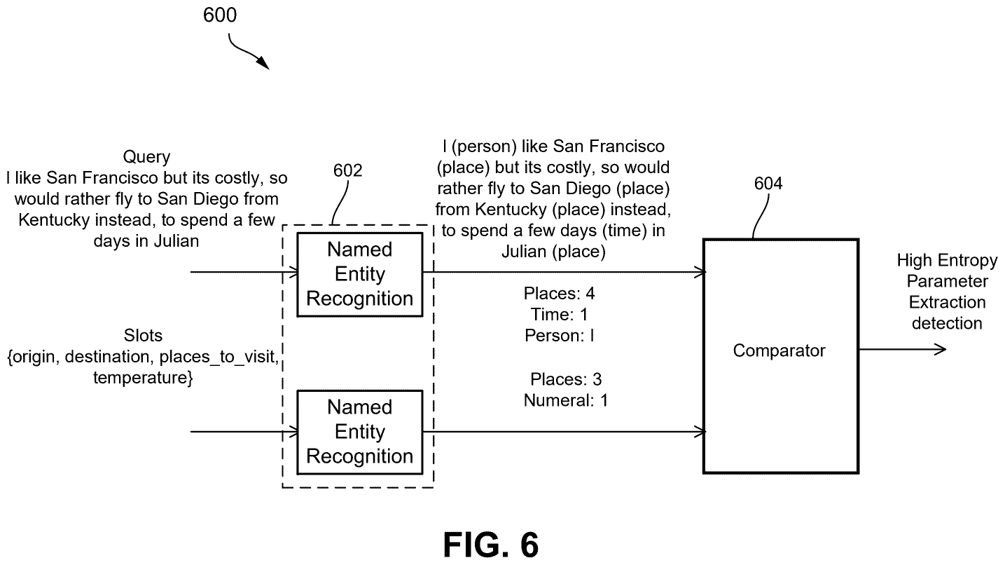

FIG. 6 is a block diagram illustrating an example entropy detection engine 600 for predicting entropy levels associated with a query. The entropy detection engine 600 includes a machine learning model 602 and a comparator 604.

The entropy detection engine 600 receives a query and input parameters (e.g., slots). For example, the query received by entropy detection engine 600 is a sentence demonstrating a user request to book a flight. The input parameters are associated with API of an application for booking flights. The entropy detection engine 600 can perform named entity recognition to extract and classify elements of the query using the machine learning model 602. The machine learning model 602 can perform named entity recognition of the input parameters to classify the input parameters. The machine learning model 602 can count the number of elements and input parameters associated with the classes.

The entropy detection engine 600 can compare the number of extracted elements and input parameters associated with a class using the comparator 604. In some examples, comparator 604 is part of the machine learning model 602. The entropy detection engine 600 determines an entropy level associated with extracted elements of the query based on deviations in the number of input parameters associated with the class and the number of extracted elements associated with the class. For example, the entropy level can be the number of deviations in numbers of extracted elements of a particular class compared to the numbers of input parameters of the particular class or preset class type (e.g., entropy level=2 when there are two more extracted elements of a class than input parameters of the class). The comparator 604 can compare the entropy level to a predetermined threshold to determine whether predictions mapping extracted elements and the input parameters would be high entropy. The entropy detection engine 600 outputs a command associated with the entropy level. When the entropy level exceeds the predetermined threshold, the entropy detection engine 600 can flag the extracted elements, query, and input parameters as high entropy, and generate instructions to an external inference engine (e.g., the external inference engine 508 of FIG. 5) to map the extracted elements to the input parameters. In some examples, the instructions can apportion elements of the query and input parameters to be mapped by the external inference engine or another machine learning model (e.g., the machine learning model 504 of FIG. 5).

FIG. 7 is a block diagram 700 illustrating independent graph mapping of extracted elements and input parameters by an external inference engine 708 (e.g., the external inference engine 508 of FIG. 5). The block diagram 700 includes a machine learning model 704 (e.g., the machine learning model 504 of FIG. 5) and the external inference engine 708.

By way of non-limiting example, the external inference engine 708 receives a set of probabilities from the machine learning model 704. The set of probabilities are associated with mapping extracted elements and input parameters. The machine learning model 704 can provide various different types of probabilities and probability distributions that the external inference engine 708 can use to map the extracted elements to the input parameters. For example, the machine learning model 704 can provide asymmetrical probability distributions. In such an example, the machine learning model 704 can provide conditional probabilities associated with assigning extracted elements to an input parameter given the query, and all possible values, i.e., P(Sᵢ=Vⱼ|Q, V_{{k}}) denoted by p_{S→V}(i, j) where {Sᵢ} represents the input parameters (e.g., slots), Q represents the query, and {Vᵢ} represents the extracted elements of the query.

In another example, the machine learning model 704 can provide a conditional probability of assigning input parameters to an extracted element of the query, and all possible input parameters of the API. This asymmetrical probability distribution can be represented by P(Vᵢ=Sⱼ|Q, S_{{k}}) where p_{S→V}(i, j). {Sᵢ} represents the input parameters (e.g., slots), Q represents the query, and {Vᵢ} represents the extracted elements of the query.

In some examples, the machine learning model 704 can provide symmetrical probability distributions. For example, the machine learning model 704 can provide a probability distribution represented by P(Sᵢ=VⱼQ, V_{{k}}, S_{{k}}). The equation denotes the probability that the i^{th} input parameter takes the j^{th} extracted element, given the user query Q, all input parameters S_{{k}}, and extracted elements V_{{k}}.

The external inference engine 708 can use the probabilities received from the machine learning model 704 to match extracted elements to input parameters using a message passing algorithm. As shown in FIG. 7, the probability of input parameters (1,2,3) matching to the extracted element “Kentucky” is obtained from p_{S→V}(1,1), p_{S→V}(2,1), p_{S→V}(3,1). The external inference engine 708 can determine the extracted element to map to input parameter 3 based on the probabilities. For example, when p_{S→V}(3,1)>> p_{S→V}(2,1) and p_{S→V}(3,1)>>p_{S→V}(1,1), the external inference engine 708 can map input parameter 3 to extracted element “Kentucky”. Based on the mapping of input parameter 3 to “Kentucky” the external inference engine 708 can perform similar calculations for input parameters 1 and 2.

The machine learning model 704 can perform independent mapping of the extracted elements of the input parameters. The independent mapping of the machine learning model 704 is represented by the machine learning model output. A joint inference engine can combine the independent mappings from the machine learning model 704 with the external inference engine 708.

FIG. 8 represents cooperative mapping 800 from an external inference engine and a machine learning model. For example, the external inference engine 808 can be external inference engines 508 and 708 from FIG. 5 and FIG. 7. The machine learning model 804 can be machine learning model 504 and 704 from FIG. 6 and FIG. 7.

Cooperative mapping 800 illustrates apportionment of extracted elements and input parameters between the machine learning model 804 and the external inference engine 802 for mapping. For example, the machine learning model 804 can map a first set of extracted elements from a query to input parameters, and the external inference engine 802 can map a second set of extracted elements from the query to the input parameters. By way of a non-limiting example, external inference engine 802 maps a subset of extracted elements from a set of extracted of elements to input parameters. The external inference engine 802 can provide results of the mapping to the machine learning model 804 for the machine learning model 804 to map additional extracted elements to input parameters. In some examples, the external inference engine 802 can provide extracted elements and input parameters that the external inference engine 802 did not map. The machine learning model 804 can map additional extracted elements and input parameters that were not mapped by the external inference engine 802.

Cooperative mapping can allow the external inference engine 802 and the machine learning model 804 to specialize in the mapping extracted elements in particular classes. For example, the machine learning model 804 can be fine-tuned or have more parameters to have higher accuracy in mapping extracted elements representing locations. In such an example, when extracted elements and input parameters associated with locations are flagged as demonstrating high entropy, the machine learning model 804 can perform the mapping. Mapping techniques are further described in the description of FIG. 7.

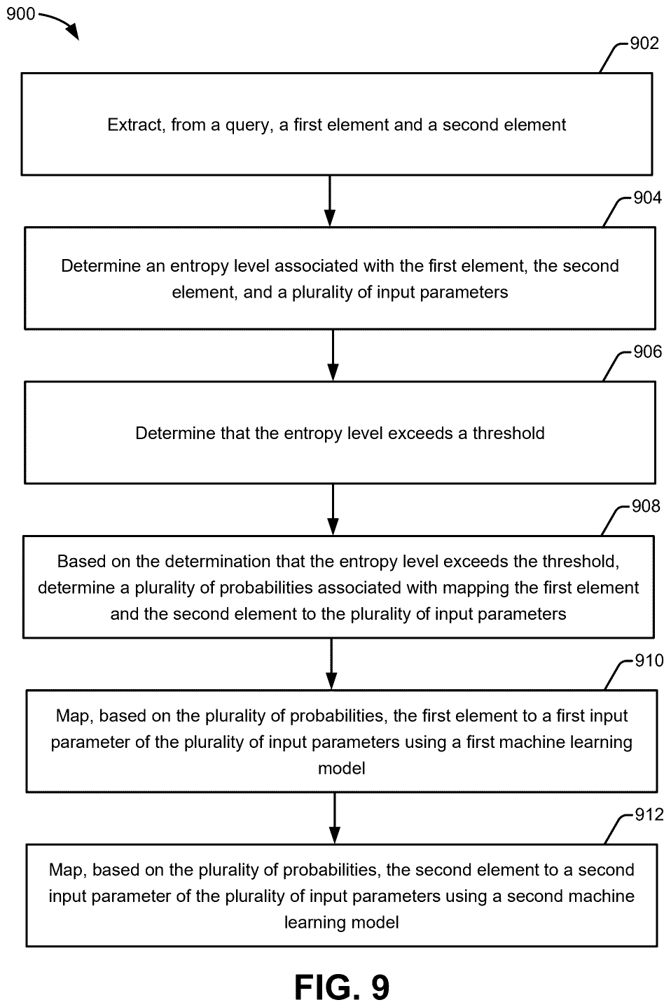

FIG. 9 is a flow diagram illustrating an example of a process 900 for high entropy parameter extraction. The process 900 can be performed by a computing device (e.g., SOC 100 of FIG. 1, computing device or computing system 1000 of FIG. 10, etc.) or by a component or system (e.g., the neural networks of FIGS. 2A-2D and FIG. 3, a chipset, one or more processors central processing units (CPUs), digital signal processors (DSPs), graphics processing units (GPUs), any other type of processor(s), any combination thereof, or other component or system) of the computing device. The operations of the process 900 can be implemented as software components that are executed and run on one or more processors (e.g., processor 1010 of FIG. 10 or other processor(s)) of the computing device. Further, the transmission and reception of signals by the computing device in the process 900 can be enabled, for example, by one or more antennas and/or one or more transceivers (e.g., wireless transceiver(s)).

At block 902, a computing device (or component thereof) can extract, from a query, a first element and a second element. The query can be a user prompt, such as a text-based (e.g., a string) request for performance of a task. In one example, the first element and the second element can be words from the query. For example, the query can be a request to book a flight such as “I would like to fly to New York tomorrow.” In some examples, the extraction can be performed by a machine learning model performing named entity recognition. The machine learning model can extract “New York” as the first element and “tomorrow” as the second element using named entity recognition.

At block 904, the computing device (or component thereof) can determine an entropy level associated with the first element, the second element, and a plurality of input parameters. In some examples, the computing device (or component thereof) determines the entropy level by comparing the number of extracted elements associated with a class to the number of input parameters associated with the class. The entropy level can represent the number of deviations in the number of input parameters associated with the class and the number of extracted elements associated with the class. For example, the entropy level can be the number of deviations in numbers of extracted elements of a particular class compared to the numbers of input parameters of the particular class (e.g., entropy level=2 when there are two more extracted elements of a class than input parameters of the class). In continuing the example of the query “I would like to fly to New York tomorrow”, the input parameters for booking a flight can include an “origin”, a “destination”, and a “date”. “Origin” and “destination” can be associated with a common class as locations. “Date” can be of a different class as a time. In such an example, the entropy level can equal 1, because the query “I would like to fly to New York tomorrow” includes only one location (e.g., New York), but there are two input parameters for booking a flight (e.g., origin and destination).

At block 906, the computing device (or component thereof) can determine that the entropy level exceeds a threshold. For example, the entropy level can be the number of deviations in the number of input parameters of a class and the number of elements of the query associated with the class. The threshold can be a predetermined number of deviations, which when exceeded, triggers the computing device (or component thereof) to perform the operations at block 908.

At block 908, the computing device (or component thereof) can determine a plurality of probabilities associated with mapping the first element and the second element to the plurality of input parameters. The computing device (or component thereof) can determine the plurality of probabilities based on the determination that the entropy level exceeds the threshold. The processor can map extracted elements to input parameters using various probabilistic techniques. In one such example, the processor can generate embedding vectors associated with extracted elements and embedding vectors associated with the input parameters. The processor can compare distances between embedding vectors associated with the extracted elements and embedding vectors associated with the input parameters in an embedding space.

At block 910, the computing device (or component thereof) can map, based on the plurality of probabilities, the first element to a first input parameter of the plurality of input parameters using a first machine learning model. The first machine learning model can be one or more of various types of machine learning models, such as an LLM, a classification model, etc. The first machine learning model can provide conditional probabilities associated with mapping an extracted element (e.g., the first element) to all possible input parameters. The first machine learning model can select which input parameter to map the first element based on the probability (e.g., the first machine learning model can map the first element to the first input parameter based on the probability being higher than alternative mappings). For example, the first machine learning model can map “New York” from the query “I would like to fly to New York tomorrow” to an input parameter of “destination”.

At block 912, the computing device (or component thereof) can map, based on the plurality of probabilities, the second element to a second input parameter of the plurality of input parameters using a second machine learning model. The second machine learning model can be one or more of various types of machine learning models, such as an LLM, a classification model, etc. For example, the second machine learning model can map “tomorrow” from the query “I would like to fly to New York tomorrow”to an input parameter of “time”.

FIG. 10 is a diagram illustrating an example of a system for implementing certain aspects of the present technology. In particular, FIG. 10 illustrates an example of computing system 1000, which can be for example any computing device making up internal computing system, a remote computing system, a camera, or any component thereof in which the components of the system are in communication with each other using connection 1005. Connection 1005 can be a physical connection using a bus, or a direct connection into processor 1010, such as in a chipset architecture. Connection 1005 can also be a virtual connection, networked connection, or logical connection.

In some aspects, computing system 1000 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example computing system 1000 includes at least one processor, such as a central processing unit (CPU), graphics processing unit (GPU), neural processing unit (NPU), digital signal processor (DSP), image signal processor (ISP), a field programmable gate array (FPGA), an application specific integrated circuit (ASIC), a microprocessor, a controller, another type of processing unit, another suitable electronic circuit, or a combination thereof. The computing system 1000 also includes a connection 1005 that couples various system components including system memory 1015, such as read-only memory (ROM) 1020 and random-access memory (RAM) 1025 to processor 1010. Computing system 1000 can include a cache 1012 of high-speed memory connected directly with, in close proximity to, or integrated as part of processor 1010.

Processor 1010 can include any general-purpose processor and a hardware service or software service, such as services 1032, 1034, and 1036 stored in storage device 1030, configured to control processor 1010 as well as a special-purpose processor where software instructions are incorporated into the actual processor design. Processor 1010 can essentially be a completely self-contained computing system, containing multiple cores or processors, a bus, memory controller, cache, etc. A multi-core processor can be symmetric or asymmetric.

To enable user interaction, computing system 1000 includes an input device 1045, which can represent any number of input mechanisms, such as a microphone for speech, a touch-sensitive screen for gesture or graphical input, keyboard, mouse, motion input, speech, etc. Computing system 1000 can also include output device 1035, which can be one or more of a number of output mechanisms. In some instances, multimodal systems can enable a user to provide multiple types of input/output to communicate with computing system 1000. Computing system 1000 can include communications interface 1040, which can generally govern and manage the user input and system output. The communication interface can perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 702.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1040 can also include one or more Global Navigation Satellite System (GNSS) receivers or transceivers that are used to determine a location of the computing system 1000 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here can easily be substituted for improved hardware or firmware arrangements as they are developed.

Storage device 1030 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 1030 can include software services, servers, services, etc. When the code that defines such software is executed by the processor 1010, the code causes the system to perform a function. In some aspects, a hardware service that performs a particular function can include the software component stored in a computer-readable medium in connection with the necessary hardware components, such as processor 1010, connection 1005, output device 1035, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium can include a non-transitory medium in which data can be stored and that does not include carrier waves and/or transitory electronic signals propagating wirelessly or over wired connections. Examples of a non-transitory medium can include, but are not limited to, a magnetic disk or tape, optical storage media such as compact disk (CD) or digital versatile disk (DVD), flash memory, memory or memory devices. A computer-readable medium can have stored thereon code and/or machine-executable instructions that can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted using any suitable means including memory sharing, message passing, token passing, network transmission, or the like.

In some aspects, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects can be practiced without these specific details. For clarity of explanation, in some instances the present technology can be presented as including individual functional blocks including functional blocks comprising devices, device components, steps or routines in a method embodied in software, or combinations of hardware and software. Additional components can be used other than those shown in the figures and/or described herein. For example, circuits, systems, networks, processes, and other components can be shown as components in block diagram form in order not to obscure the aspects in unnecessary detail. In other instances, well-known circuits, processes, algorithms, structures, and techniques can be shown without unnecessary detail in order to avoid obscuring the aspects.

Individual aspects can be described above as a process or method which is depicted as a flowchart, a flow diagram, a data flow diagram, a structure diagram, or a block diagram. Although a flowchart can describe the operations as a sequential process, many of the operations can be performed in parallel or concurrently. In addition, the order of the operations can be re-arranged. A process is terminated when its operations are completed but could have additional steps not included in a figure. A process can correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions can be, for example, binaries, intermediate format instructions such as assembly language, firmware, source code, etc. Examples of computer-readable media that can be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) can be stored in a computer-readable or machine-readable medium. A processor(s) can perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts can be otherwise variously embodied and employed, and that the appended claims are intended to be construed to include such variations, except as limited by the prior art. Various features and aspects of the above-described application can be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods can be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” means A, B, or A and B. In another example, claim language reciting “at least one of A, B, and C” means A, B, C, or A and B, or A and C, or B and C, or A and B and C. The language “at least one of” a set and/or “one or more” of a set does not limit the set to the items listed in the set. For example, claim language reciting “at least one of A and B” can mean A, B, or A and B, and can additionally include items not listed in the set of A and B.

The various illustrative logical blocks, modules, circuits, and algorithm steps described in connection with the aspects disclosed herein can be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans can implement the described functionality in varying ways for each particular application, but such implementation decisions should not be interpreted as causing a departure from the scope of the present application.

The techniques described herein can also be implemented in electronic hardware, computer software, firmware, or any combination thereof. Such techniques can be implemented in any of a variety of devices such as general purposes computers, wireless communication device handsets, or integrated circuit devices having multiple uses including application in wireless communication device handsets and other devices. Any features described as modules or components can be implemented together in an integrated logic device or separately as discrete but interoperable logic devices. If implemented in software, the techniques can be realized at least in part by a computer-readable data storage medium comprising program code including instructions that, when executed, performs one or more of the methods described above. The computer-readable data storage medium can form part of a computer program product, which can include packaging materials. The computer-readable medium can comprise memory or data storage media, such as random-access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, can be realized at least in part by a computer-readable communication medium that carries or communicates program code in the form of instructions or data structures and that can be accessed, read, and/or executed by a computer, such as propagated signals or waves.

The program code can be executed by a processor, which can include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor can be configured to perform any of the techniques described in this disclosure. A general-purpose processor can be a microprocessor; but in the alternative, the processor can be any conventional processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein can refer to any of the foregoing structure, any combination of the foregoing structure, or any other structure or apparatus suitable for implementation of the techniques described herein. In addition, in some aspects, the functionality described herein can be provided within dedicated software modules or hardware modules configured for encoding and decoding or incorporated in a combined video encoder-decoder (CODEC).

Claim language or other language reciting “at least one processor configured to,” “at least one processor being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor can only perform at least a subset of operations X, Y, and Z.

Illustrative aspects of the disclosure include:

Aspect 1: An apparatus for parameter extraction of one or more queries, the apparatus comprising: at least one memory; and at least one processor coupled to the at least one memory and configured to: extract, from a query, a first element and a second element; determine an entropy level associated with the first element, the second element, and a plurality of input parameters; determine that the entropy level exceeds a threshold; based on the determination that the entropy level exceeds the threshold, determine a plurality of probabilities associated with mapping the first element and the second element to the plurality of input parameters; map, based on the plurality of probabilities, the first element to a first input parameter of the plurality of input parameters using a first machine learning model; and map, based on the plurality of probabilities, the second element to a second input parameter of the plurality of input parameters using a second machine learning model.

Aspect 2: The apparatus of Aspect 1, wherein the at least one processor is configured to: generate a first embedding vector associated with the query and a second embedding vector associated with the plurality of input parameters; and determine the plurality of probabilities based on positions of elements of the first embedding vector in an embedding space relative to positions of input parameters of the second embedding vector in the embedding space.

Aspect 3: The apparatus of any of Aspects 1 to 2, wherein the at least one processor is configured to: extract the first element and the second element using a third machine learning model configured to perform named entity recognition.

Aspect 4: The apparatus of any of Aspects 1 to 3, wherein the first element comprises one or more words from the query.

Aspect 5: The apparatus of any of Aspects 1 to 4, wherein the plurality of input parameters includes associated with an application programming interface configured to perform an action based on the mapping of the first element to the first input parameter and the mapping of the second element to the second input parameter.

Aspect 6: The apparatus of any of Aspects 1 to 5, wherein the plurality of probabilities includes conditional probabilities associated with a mapping of the first element and the second element to the plurality of input parameters.

Aspect 7: The apparatus of any of Aspects 1 to 6, wherein the first machine learning model is a first large language model (LLM), and the second machine learning model is a second LLM with fewer parameters than the first LLM.

Aspect 8: The apparatus of any of Aspects 1 to 7, wherein the at least one processor is configured to: map the first element using the first machine learning model and the second machine learning model.

Aspect 9: The apparatus of any of Aspects 1 to 8, wherein the at least one processor is configured to: classify the first element as associated with a first class; classify a third element as associated with the first class; compare a number of elements associated with the first class and a number of input parameters associated with the first class; and determine the entropy level exceeds the threshold based on the number of elements associated with the first class being greater than the number of input parameters associated with the first class.

Aspect 10: The apparatus of any of Aspects 1 to 9, wherein the at least one processor is configured to: classify the first element and the second element using named entity recognition; wherein the first class is a preset class type associated with the plurality of input parameters.

Aspect 11: The apparatus of any of Aspects 1 to 10, wherein the entropy level is a number representing a difference in the number of elements associated with the first class and the number of input parameters associated with the first class.

Aspect 12: The apparatus of any of Aspects 1 to 11, wherein the at least one processor is configured to: determine to use the first machine learning model and the second machine learning model based on a trigger condition, the trigger condition comprising that the entropy level associated with the first element, the second element, and the plurality of input parameters exceeds the threshold.

Aspect 13: A method for parameter extraction of one or more queries, the method comprising: extracting, from a query, a first element and a second element; determining an entropy level associated with the first element, the second element, and a plurality of input parameters; determining that the entropy level exceeds a threshold; based on the determination that the entropy level exceeds the threshold, determine a plurality of probabilities associated with mapping the first element and the second element to the plurality of input parameters; mapping, based on the plurality of probabilities, the first element to a first input parameter of the plurality of input parameters using a first machine learning model; and mapping, based on the plurality of probabilities, the second element to a second input parameter of the plurality of input parameters using a second machine learning model.

Aspect 14: The method of Aspect 13, further comprising: generating a first embedding vector associated with the query and a second embedding vector associated with the plurality of input parameters; and determining the plurality of probabilities based on positions of elements of the first embedding vector in an embedding space relative to positions of input parameters of the second embedding vector in the embedding space.

Aspect 15: The method of any of Aspects 13 to 14, further comprising: extracting the first element and the second element using a third machine learning model configured to perform named entity recognition.

Aspect 16: The method of any of Aspects 13 to 15, wherein the first element comprises one or more words from the query.

Aspect 17: The method of any of Aspects 13 to 16, wherein the plurality of input parameters includes associated with an application programming interface configured to perform an action based on the mapping of the first element to the first input parameter and the mapping of the second element to the second input parameter.

Aspect 18: The method of any of Aspects 13 to 17, wherein the plurality of probabilities includes conditional probabilities associated with a mapping of the first element and the second element to the plurality of input parameters.

Aspect 19: The method of any of Aspects 13 to 18, wherein the first machine learning model is a first large language model (LLM), and the second machine learning model is a second LLM with fewer parameters than the first LLM.

Aspect 20: The method of any of Aspects 13 to 19, further comprising: mapping the first element using the first machine learning model and the second machine learning model.

Aspect 21: The method of any of Aspects 13 to 20, further comprising: classifying the first element as associated with a first class; classifying a third element as associated with the first class; comparing a number of elements associated with the first class and a number of input parameters associated with the first class; and determining the entropy level exceeds the threshold based on the number of elements associated with the first class being greater than the number of input parameters associated with the first class.

Aspect 22: The method of any of Aspects 13 to 21, further comprising: classifying the first element and the second element using named entity recognition, wherein the first class is a preset class type associated with the plurality of input parameters.

Aspect 23: The method of any of Aspects 13 to 22, wherein the entropy level is a number representing a difference in the number of elements associated with the first class and the number of input parameters associated with the first class.

Aspect 24: The method of any of Aspects 13 to 23, further comprising: determining to use the first machine learning model and the second machine learning model based on a trigger condition, the trigger condition comprising that the entropy level associated with the first element, the second element, and the plurality of input parameters exceeds the threshold.

Aspect 25: A non-transitory computer-readable medium having stored thereon instructions that, when executed by one or more processors, cause the one or more processors to perform operations according to any of Aspects 13 to 24.

Aspect 26: An apparatus for optimizing parameter extraction, the apparatus comprising one or more means for performing operations according to any of Aspects 13 to 24.

1. An apparatus for parameter extraction of one or more queries, the apparatus comprising:
at least one memory; and
at least one processor coupled to the at least one memory and configured to:
extract, from a query, a first element and a second element;
determine an entropy level associated with the first element, the second element, and a plurality of input parameters;
determine that the entropy level exceeds a threshold;
in response to the determination that the entropy level exceeds the threshold, determine a plurality of probabilities associated with mapping the first element and the second element to the plurality of input parameters, the plurality of probabilities comprising a first set of probabilities and a second set of probabilities, the first set of probabilities comprising, for each respective input parameter of the plurality of input parameters, a respective first probability corresponding to mapping the first element to the respective input parameter, and the second set of probabilities comprising, for each respective input parameter of the plurality of input parameters, a respective second probability corresponding to mapping the second element to the respective input parameter;
map, based on the first set of probabilities, the first element to a first input parameter of the plurality of input parameters using a first machine learning model; and
map, based on the second set of probabilities, the second element to a second input parameter of the plurality of input parameters using a second machine learning model.

2. The apparatus of claim 1, wherein the at least one processor is configured to:
generate a first embedding vector associated with the query and a second embedding vector associated with the plurality of input parameters; and
determine the plurality of probabilities based on positions of elements of the first embedding vector in an embedding space relative to positions of input parameters of the second embedding vector in the embedding space.

3. The apparatus of claim 1, wherein extracting the first element and the second element comprises extracting the first element and the second element using a third machine learning model based on named entity recognition.

4. The apparatus of claim 1, wherein the first element comprises one or more words from the query.

5. The apparatus of claim 1, wherein the plurality of input parameters are associated with an application programming interface, the application programming interface performing an action based on the mapping of the first element to the first input parameter and the mapping of the second element to the second input parameter.

6. The apparatus of claim 1, wherein the first set of probabilities and the second set of probabilities include conditional probabilities associated with a mapping of the first element and the second element to the plurality of input parameters, respectively.

7. The apparatus of claim 1, wherein the first machine learning model is a first large language model (LLM), and the second machine learning model is a second LLM with fewer parameters than the first LLM.

8. The apparatus of claim 1, wherein mapping the first element comprises mapping the first element using the first machine learning model and the second machine learning model.

9. The apparatus of claim 1, wherein the at least one processor is configured to:
classify the first element as associated with a first class;
classify a third element, extracted from the query, as associated with the first class;
compare a number of elements associated with the first class and a number of input parameters associated with the first class; and
determine the entropy level exceeds the threshold based on the number of elements associated with the first class being greater than the number of input parameters associated with the first class.

10. The apparatus of claim 9, wherein the at least one processor is configured to:
classify the first element and the second element using named entity recognition;
wherein the first class is a preset class type associated with the plurality of input parameters.

11. The apparatus of claim 9, wherein the entropy level is a number representing a difference in the number of elements associated with the first class and the number of input parameters associated with the first class.

12. The apparatus of claim 1, wherein the at least one processor is configured to:
determine to use the first machine learning model and the second machine learning model based on a trigger condition, the trigger condition comprising that the entropy level associated with the first element, the second element, and the plurality of input parameters exceeds the threshold.

13. A method for parameter extraction of one or more queries, the method comprising:
extracting, from a query, a first element and a second element;
determining an entropy level associated with the first element, the second element, and a plurality of input parameters;
determining that the entropy level exceeds a threshold;
in response to the determination that the entropy level exceeds the threshold, determining a plurality of probabilities associated with mapping the first element and the second element to the plurality of input parameters, the plurality of probabilities comprising a first set of probabilities and a second set of probabilities, the first set of probabilities comprising, for each respective input parameter of the plurality of input parameters, a respective first probability corresponding to mapping the first element to the respective input parameter, and the second set of probabilities comprising, for each respective input parameter of the plurality of input parameters, a respective second probability corresponding to mapping the second element to the respective input parameter;
mapping, based on the first set of probabilities, the first element to a first input parameter of the plurality of input parameters using a first machine learning model; and
mapping, based on the second set of probabilities, the second element to a second input parameter of the plurality of input parameters using a second machine learning model.

14. The method of claim 13, further comprising:
generating a first embedding vector associated with the query and a second embedding vector associated with the plurality of input parameters; and
determining the plurality of probabilities based on positions of elements of the first embedding vector in an embedding space relative to positions of input parameters of the second embedding vector in the embedding space.

15. The method of claim 13, wherein extracting the first element and the second element comprises extracting the first element and the second element using a third machine learning model based on named entity recognition.

16. The method of claim 13, wherein the first element comprises one or more words from the query.

17. The method of claim 13, wherein the plurality of input parameters are associated with an application programming interface, the application programming interface performing an action based on the mapping of the first element to the first input parameter and the mapping of the second element to the second input parameter.

18. The method of claim 13, wherein the first set of probabilities and the second set of probabilities include conditional probabilities associated with a mapping of the first element and the second element to the plurality of input parameters, respectively.

19. The method of claim 13, wherein the first machine learning model is a first large language model (LLM), and the second machine learning model is a second LLM with fewer parameters than the first LLM.

20. A non-transitory computer readable medium storing code for optimizing parameter extraction, the code comprising instructions executable by a processor to:
extract, from a query, a first element and a second element;
determine an entropy level associated with the first element, the second element, and a plurality of input parameters;
determine that the entropy level exceeds a threshold;
in response to the determination that the entropy level exceeds the threshold, determine a plurality of probabilities associated with mapping the first element and the second element to the plurality of input parameters, the plurality of probabilities comprising a first set of probabilities and a second set of probabilities, the first set of probabilities comprising, for each respective input parameter of the plurality of input parameters, a respective first probability corresponding to mapping the first element to the respective input parameter, and the second set of probabilities comprising, for each respective input parameter of the plurality of input parameters, a respective second probability corresponding to mapping the second element to the respective input parameter;
map, based on the first set of probabilities, the first element to a first input parameter of the plurality of input parameters using a first machine learning model; and
map, based on the second set of probabilities, the second element to a second input parameter of the plurality of input parameters using a second machine learning model.
